(19) United States
(12) Patent Application Publication
(10) Pub. No.: US 2008/0136672 A1
(43) Pub. Date: Jun. 12, 2008

(54) SINGLE SCREEN PEDESTRIAN LIGHT

(76) Inventor: Yih-Jiun SHEN, Kaohsiung (TW)

Correspondence Address: PATENTTM.US, P. O. BOX 82788, PORTLAND, OR, 97282-0788, US

(21) Appl. No.: 11/608,774

(22) Filed: Dec. 8, 2006

(51) Int. Cl. G08G 1/096

(52) U.S. Cl. 340/929; 340/944

(57) ABSTRACT

A pedestrian light has a base, a circuit board mounted in the base, an LED panel mounted in the base and a protect lid mounted on the base to cover the circuit board and the LED panel. The LED panel has an outer loop region and an inner rectangular region. The circuit board control the inner rectangular region to display a traffic sign such as a walk or a stop sign, and also controls the outer loop region to show countdown information about the remaining seconds after which the present displayed traffic sign will be changed. Since the pedestrian light uses only a single screen to display the traffic sign and countdown information, more space can be saved, and the traffic light can be displayed in a larger size to improve the recognition on traffic signs at pedestrian crossing.

### BACKGROUND OF THE INVENTION

1. Field of the Invention

The present invention relates to a pedestrian light, especially to a pedestrian light that simultaneously displays a traffic sign and countdown information on the same screen.

2. Description of the Prior Arts

The traffic signs mainly comprise dynamic type and static type. The static traffic signs, such as road signs, are suitable for indicating traffic rules or speed limitations. The dynamic traffic signs are often composed of lights, for instance, the traffic lights or pedestrian lights.

The conventional red and green traffic lights are designed not only for vehicles but also for pedestrians. When a green light is going to turn to a red light, the green light can warn pedestrians by flashing. However, merely based on the flashing light, pedestrians are unable to know the remained seconds for walking through the zebra crossing. That is a safety issue!

Therefore, a pedestrian light with an upper screen and a lower screen was developed to assist pedestrians. During the green light, the lower screen displays a green dynamic sign of a walking person while the upper screen shows the remaining time. When the green light is going to turn to a red light, the green sign on the lower screen will warn pedestrians by flashing and then eventually become a red sign of a standing person.

Although, the present pedestrian lights have provided the countdown function but the dual screens still take twofold space and cost.

To overcome the shortcomings, the present invention provides a new pedestrian light to mitigate or obviate the aforementioned problems.

### SUMMARY OF THE INVENTION

The main objective of the present invention is to provide a pedestrian light capable of simultaneously displaying a walk or stop sign and countdown information on the same screen.

The pedestrian light has a base, a circuit board mounted in the base, an LED panel mounted in the base and a protect lid mounted on the base. The LED panel has an outer loop region and an inner rectangular region. The inner rectangular region composed of multiple LEDs is able to display a walk or a stop sign in green and red light respectively. The outer loop region composed of multiple LEDs is able to indicate the remained seconds. In other words, a single display screen can show the pedestrian light with countdown information. Furthermore, the pedestrian light with a single display screen requires less fabricating and upkeep costs in comparison with multiple display screens of the conventional pedestrian lights.

Another objective of the present invention is to provide a pedestrian light capable of adjusting brightness of the LEDs. The pedestrian light uses an optical sensor to detect the intensity of light of surroundings. Based on the detected result, the circuit board can accordingly adjust the brightness of the LEDs on the LED panel.

Other objectives, advantages and novel features of the invention will become more apparent from the following detailed description when taken in conjunction with the accompanying drawings.

### BRIEF DESCRIPTION OF THE DRAWINGS

FIG. 1 is an exploded cross section view of a pedestrian light in accordance with the present invention;

FIG. 2 is a block diagram of a control circuit for the pedestrian light in accordance with the present invention;

FIG. 3 is a plan view of the pedestrian light in accordance with the present invention;

FIG. 4 is an operational view of the pedestrian light in accordance with the present invention showing a green dynamic sign of a walking person and a countdown indication of 35 seconds; and

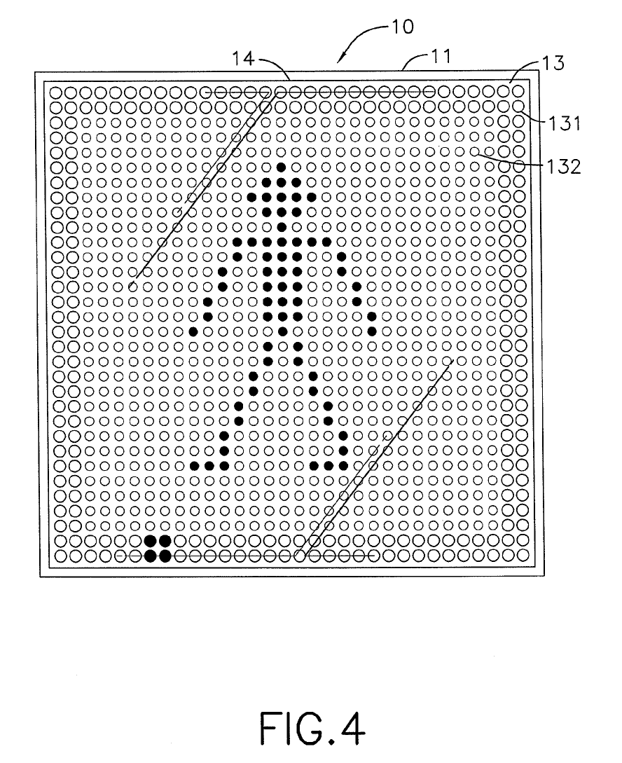

FIG. 5 is an operational view of the pedestrian light in accordance with the present invention showing a red static sign of a standing person and a countdown indication of 20 seconds.

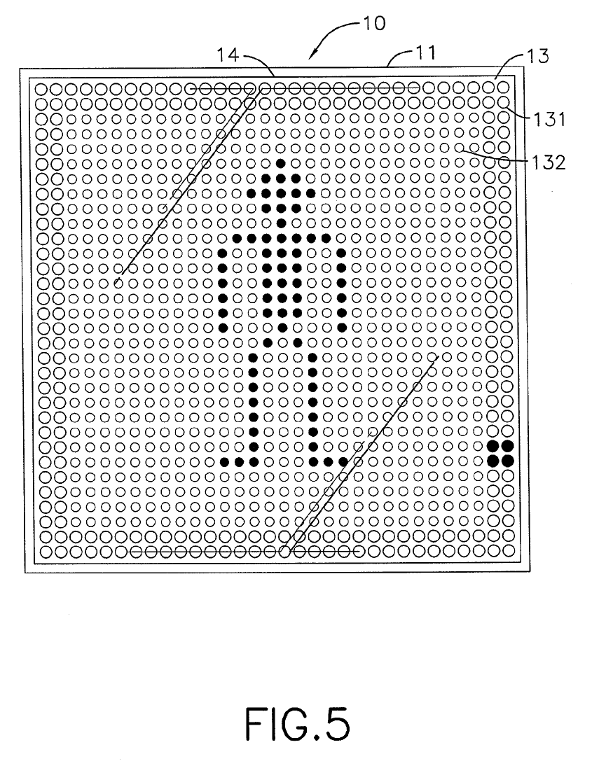

### DETAILED DESCRIPTION OF THE PREFERRED EMBODIMENTS

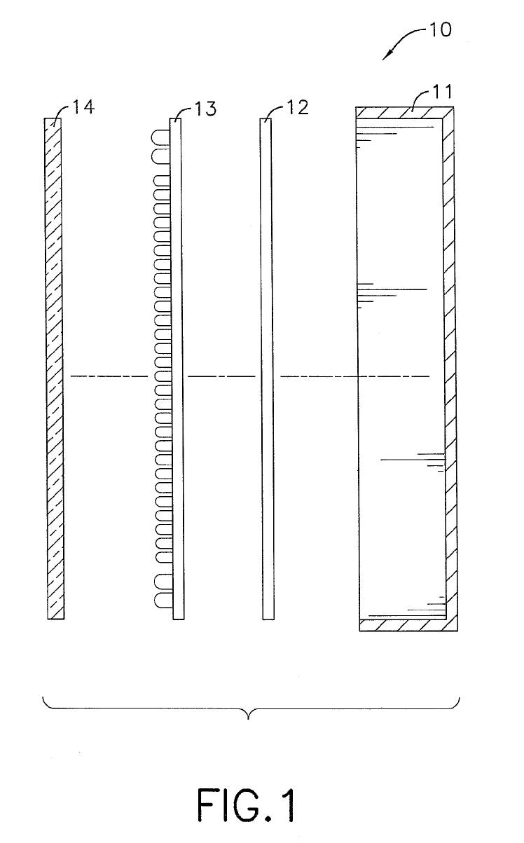

With reference to FIG. 1, a single screen pedestrian light (10) in accordance with the present invention comprises a base (11), a circuit board (12), an LED panel (13) and a protect lid (14).

The protect lid (14) can be made of translucent or transparent material and is mounted on the base (11) to cover the circuit board (12) and the LED panel (13).

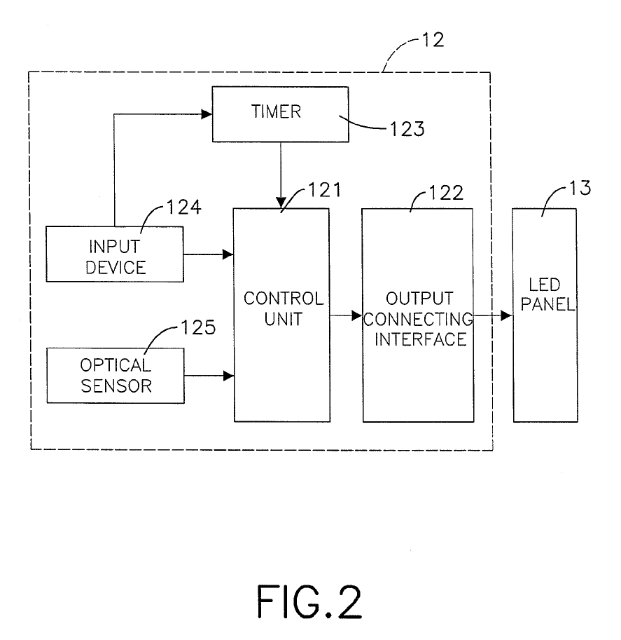

With reference to FIG. 2, the circuit board (12) of the pedestrian light (10) comprises a control unit (121), an output connecting interface (122), a timer (123), an input device (124) and an optical sensor (125).

The output connecting interface (122) is connected between an output terminal of the control unit (121) and an input terminal of the LED panel (13). Through the output connecting interface (122), the control unit (121) can turn on or turn off each of the LEDs and controls their color and brightness.

The timer (123) has an output terminal connected to input terminal of the control unit (121) and an input terminal connected to output terminal of the input device (124).

The input device (124) can be a key set or a switch set, and has output terminals connected to the control unit (121) and timer (123) for setting operation parameters to the control unit (121) and timer (123).

The optical sensor (125) connected to the control unit (121) detects the intensity of the light of the surroundings. Accordingly, the detected result is transmitted to the control unit (121) to adjust the brightness of LED panel (13).

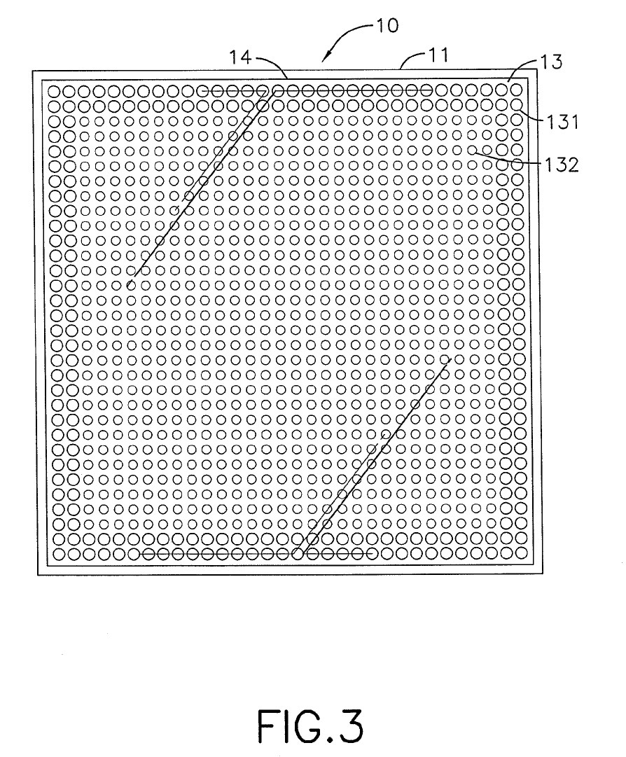

The LED panel (13) is mounted in the base (11) and electrically connects to the circuit board (12). The LED panel (13) composed of multiple LEDs with different colors can display different colors and signs based on driving signals from the control unit (121). As shown in FIG. 3, the LED panel (13) has two display regions. The first display region is an outer loop region (131). The second display region is an inner rectangular region (132) within the outer loop region (131).

Furthermore, the outer loop region (131) of LED panel (13) provides a function of showing countdown information. For example, the entire outer loop region (131) can be divided into sixty sections corresponding to sixty seconds of a clock. When the inner rectangular region (132) displays the walk or stop sign, the originally activated sixty sections of LEDs on the outer loop region (131) can be either sequentially turned off in a counterclockwise direction to show the remaining seconds or sequentially turned off for one second in a counterclockwise direction to generate a visual effect of a moving dot as a second hand pointing to the countdown seconds. Alternatively, the sixty sections of LEDs on the outer loop region (131) are sequentially turned on for one second in a counterclockwise direction to generate a visual effect of a moving light dot. The countdown of remained time may be less than 60 seconds or longer than 1 minute subjected to the traffic load at crossroad but the countdown indications above are activated well while the setting of countdown is less than 61 seconds.

Therefore, pedestrians can easily recognize the pedestrian light from the inner rectangular region (132) and the remaining seconds from the out loop region (131). Accordingly, the dual screens of conventional pedestrian lights can be integrated as a single pedestrian light.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A single screen pedestrian light comprising:
a base;
a circuit board mounted in the base;
a light emitting diode (LED) panel mounted in the base and having
an outer loop region composed of multiple light emitting diodes (LEDs) controlled by the circuit board to show countdown information about remaining seconds; and
an inner rectangular region within the outer region, composed of multiple light emitting diodes (LEDs), and controlled by the circuit board to show a traffic symbol for pedestrians; and
a protect lid mounted in the base to cover the circuit board and the LED panel in the base.

2. The pedestrian light as claimed in claim 1, the circuit board comprising:
a control unit;
an output connecting interface connected between the control unit and the LED panel, wherein the control unit controls the LEDs of the LED panel through the output connecting interface;
a timer having an output terminal connected to the control unit and an input terminal connected to the input device; and
an input device connected to the control unit and the timer for setting control parameters to the control unit and the timer;
an optical sensor connected to the control unit to detect intensity of light of surroundings and then transmitting a sensed signal to the control unit so that the control unit adjusts brightness of the LEDs on the LED panel based on the detected signal.

3. The pedestrian light as claimed in claim 1, wherein all LEDs of the outer loop region are divided into sixty sections corresponding to sixty seconds of a clock.

4. The pedestrian light as claimed in claim 3, wherein sixty sections of LEDs in the outer loop region are initially turned on then sequentially turned off in a counterclockwise direction to show the countdown information.

5. The pedestrian light as claimed in claim 3, wherein sixty sections of LEDs in the outer loop region are initially turned on then sequentially turned off for one second in a counterclockwise direction to generate a moving dot as a second hand.

6. The pedestrian light as claimed in claim 3, wherein sixty sections of LEDs in the outer loop region are sequentially turned on for one second in a counterclockwise direction to generate a moving light dot to indicate the remaining seconds.

7. The pedestrian light as claimed in claim 1, wherein a traffic sign displayed on the inner rectangular region is either a green walk sign or a red stop sign.

8. The pedestrian light as claimed in claim 2, wherein the optical sensor detects the intensity of light of surroundings to adjust brightness of the LED panel through the control unit.

9. The pedestrian light as claimed in claim 1, wherein the protect lid is a translucent or transparent lid.
